(19) United States
(12) Patent Application Publication
(10) Pub. No.: US 2023/0189246 A1
(43) Pub. Date: Jun. 15, 2023

(54) ORTHOGONAL FREQUENCY-DIVISION MULTIPLE ACCESS (OFDMA) SCHEDULE ALIGNMENT FOR MESH NETWORKING

(71) Applicant: ARRIS Enterprises LLC, Suwanee, GA (US)

(72) Inventor: Ian G. WHEELOCK, Cork (IE)

(21) Appl. No.: 18/070,711

(22) Filed: Nov. 29, 2022

Related U.S. Application Data
(60) Provisional application No. 63/288,851, filed on Dec. 13, 2021.

(51) Int. Cl. H04W 72/12

(52) U.S. Cl. CPC H04W 72/12

(57) ABSTRACT

A network device for aligning Orthogonal Frequency-Division Multiple Access (OFDMA) schedules across nodes in a multi-hop network. An observed OFDMA repetitive schedule associated with a client device that repeatedly requests a grant to transmit traffic is obtained. A derived OFDMA repetitive schedule is determined for transmission of traffic by the client device. The derived OFDMA repetitive schedule may be determined by a network node coupled to the client device, a neighbor network device, an edge gateway, a system controller, etc. The network device may use the derived OFDMA repetitive schedule when it determines the derived OFDMA repetitive schedule itself, or it may receive the derived OFDMA repetitive schedule from another network device, such as a neighboring network device, an edge gateway, or a system controller.

BACKGROUND

A standard router acts as a central hub for Internet connectivity. Traffic and requests from devices are granted permission to connect to the router , wherein the router allows a client device to connect to another network, such as the Internet. While traditional routers are singular, centralized access points, mesh networking devices are decentralized. Instead of a device connecting to a single gateway to the Internet, mesh networks are created from multiple nodes that are interconnected. In a mesh network, each node acts as a router/repeater for other nodes in the network. These nodes can be fixed pieces of network infrastructure and/or can be the mobile devices themselves. Thus a mesh network provides a decentralized and inexpensive network, where each node need only to transmit as far as the next node, rather than to the ultimate destination. This allows a mesh network to span large distances, provide high data rates, and create non-line-of-sight connections.

In a daisy chained or multi-hop star mesh network, multiple access points (APs) or extenders (EXTs) are used to enable stations (STAs) associated at the edge of the mesh network to communicate to a primary mesh exit point in order to reach the Internet (or other services, e.g., an enterprise environment). Often times this is a broadband gateway (GW) or other type of Access Point (AP). Similarly, traffic destined for a STA from the Internet or enterprise environment must also traverse the multiple hops in the mesh network. In the normal setting of CSMA/CA Wi-Fi, there is no realistic scheduling available. Thus, devices must contend for access in order to transmit data.

When data is transmitted from one end of the mesh to the other (in either direction), data is queued at each node, whether STA, GW, AP or EXT, until it can be transmitted to the Wi-Fi network. A receiving AP or EXT will then attempt to transmit this traffic again to its next hop. This process is repeated until it reaches its destination within the mesh network.

Each mesh node will receive traffic from multiple sources and queue this traffic towards the traffic's destination. Wireless networks generally provide all clients with equal bandwidth access. However, delays or reductions in throughput can adversely affect voice and video applications, resulting in disrupted VoIP conversations or dropped frames in a streamed video. Thus, data streams that require strict latency and throughput need to be assigned higher traffic priority than other traffic types. A mixture of traffic may be queued on a FIFO basis, either with or without User Priority/Wi-Fi Multimedia (WMM) queueing. WMM provides basic Quality of service (QoS) features to networks by prioritizing traffic according to Access Categories (AC): voice (AC_VO), video (AC_VI), best effort (AC_BE), and background (AC_BK). However, WMM does not provide guaranteed throughput.

The queueing of traffic increases latency, which can be further delayed as a result of latency associated with CSMA/CA access and the modulation coding scheme (MCS) rate used for transmission where bit transmissions take longer at lower MCS rates.

### SUMMARY

An aspect of the present disclosure involves a system and method for aligning multiple Orthogonal Frequency-Division Multiple Access (OFDMA) scheduler grants to minimize end-to-end latency in mesh networks. The lowest possible latency between input and output is ensured through the exchange of OFDMA schedule to align traffic schedules across devices in a mesh network that aligns data arrival at a mesh node with data transmission from that mesh node.

A network device for aligning Orthogonal Frequency-Division Multiple Access (OFDMA) schedules across nodes in a multi-hop network, includes a memory storing computer-readable instructions, and a processor configured to execute the computer-readable instructions to obtain a first observed OFDMA repetitive schedule associated with a client device repeatedly requesting a grant to transmit traffic, and to determine a first derived OFDMA repetitive schedule for transmission of traffic by the client device.

The first derived OFDMA repetitive schedule is used for transmission of traffic by the client device in one of a downstream flow or an upstream flow.

The processor may implement a gateway for controlling access to a second network by the nodes in the multi-hop network.

The processor communicates directly with a first node in the multi-hop network, the first node being coupled to the client device, wherein the processor obtains the first observed OFDMA repetitive schedule associated with the client device directly from the first node, and wherein the processor sends the first derived OFDMA repetitive schedule directly to the first node.

The processor communicates with an intermediary node positioned between the network device and a subsequent node in the multi-hop network, the client device being coupled to the subsequent node, and wherein the processor obtains the first observed OFDMA repetitive schedule associated with the client device relayed by the intermediary node from the subsequent node and sends the first derived OFDMA repetitive schedule to the intermediary node for relaying to the subsequent node to use transmission of traffic by the client device.

The processor provides a system controller, wherein the system controller communicates with each node in the multi-hop network.

The system controller is coupled to each of N nodes in the multi-hop network, wherein the system controller obtains N observed OFDMA repetitive schedules, each of the N observed OFDMA repetitive schedules associated with a respective one of the N nodes in the multi-hop network, determines N derived OFDMA repetitive schedules based on the N observed OFDMA repetitive schedules, each of the N derived OFDMA repetitive schedules associated with the respective one of the N nodes in the multi-hop network. and provides the N derived OFDMA repetitive schedules to the respective one of the N nodes in the multi-hop network for transmitting traffic.

### BRIEF SUMMARY OF THE DRAWINGS

The accompanying drawings, which are incorporated in and form a part of the specification, illustrate examples of the subject matter of the present disclosure and, together with the description, serve to explain the principles of the present disclosure. In the drawings:

FIG. 1 show a multi-hop network.

FIG. 2 illustrates distribution of traffic for stations coupled to Extender 2.

FIG. 3 shows a system that uses a System Controller for performing schedule derivation.

FIG. 4 shows Type-Length Values (TLVs) for anticipated channel usage.

FIG. 5 shows a network device for aligning multiple Orthogonal Frequency-Division Multiple Access (OFDMA) scheduler grants to minimize end-to-end latency in mesh networks.

FIG. 6 is a flow chart of a method for aligning multiple Orthogonal Frequency-Division Multiple Access (OFDMA) scheduler grants to minimize end-to-end latency in mesh networks.

### DETAILED DESCRIPTION

The following detailed description is made with reference to the accompanying drawings and is provided to assist in a comprehensive understanding of various example embodiments of the present disclosure. The following description includes various details to assist in that understanding, but these are to be regarded merely as examples and not for the purpose of limiting the present disclosure as defined by the appended claims and their equivalents. The words and phrases used in the following description are merely used to enable a clear and consistent understanding of the present disclosure. In addition, descriptions of well-known structures, functions, and configurations may have been omitted for clarity and conciseness.

Aspects of the present disclosure are directed to aligning multiple Orthogonal Frequency-Division Multiple Access (OFDMA) scheduler grants to minimize end-to-end latency in mesh networks. The lowest possible latency between input and output is ensured through the exchange of OFDMA schedule to align traffic schedules across devices in a mesh network that aligns data arrival at a mesh node with data transmission from that mesh node. The observed schedules can be based on an explicit traffic specification exchanged between a STA and the mesh network, or through the data analysis of live traffic that identifies unique low latency transmissions, for example, based on queue dwell time and queue building within unique flow queues. Once a specific traffic flow is identified that requires low latency, the mesh network nodes close (near) to where the traffic originated set up OFDMA schedule access per hop, on each of the connected nodes, in the direction of the destination node. Data analysis of traffic is used to optimize traffic by marking such traffic with a specific UP/WMM marking.

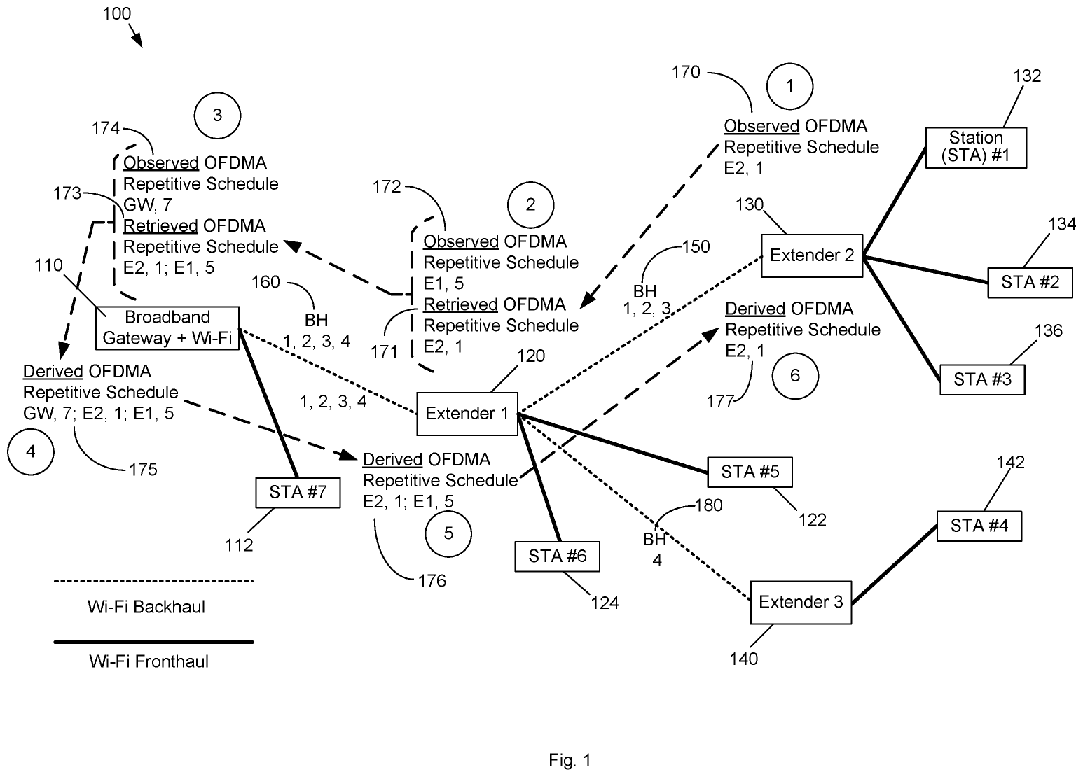

FIG. 1 show a multi-hop network 100.

In FIG. 1, a Broadband Gateway 110 is provided to provide a mesh exit point in order to reach the Internet (or other services, e.g., an enterprise environment). A station, STA #7 112 is coupled directly to broadband gateway 110. Extender 1 120 is also coupled to broadband gateway 110. Extender 1 120 is coupled to STA #5 122 and STA #6 124. Extender 2 130 is coupled to Extender 1 120. Extender 2 130 is coupled to STA #1 132, STA #2 134, and STA #3 136. Extender 3 140 is also coupled to Extender 1 120. Extender 3 140 is coupled to STA #4 142. Transmission grants are requested by STA #1 132, STA #2 134, STA #3 134, STA #4 142, STA #5 122, STA #6 124, STA #7 112.

STA #1 132 requests that Extender 2 130 grant STA #1 132 a time to transmit traffic from STA #1 132. Extender 2 130 develops a schedule for STA #1 132, and Extender 2 will hand over grants periodically to STA #1 132 to satisfy demands of STA #1 132 to transmit for STA #1 132. As Extender 2 130 receives data from STA #1 132 and passes it on again to Extender 1 120, Extender 2 sends the data from STA #1 132 over a backhaul link 150. Backhaul link 150 may be used by Extender 2 130 to handle traffic of STA #2 134 and STA #3 136. The traffic that STA #1 132, STA #2 134, and STA #3 136 produce typically end up in a single queue in Extender 2 130, and the data is sent on to Extender 1 120 on an as needed basis.

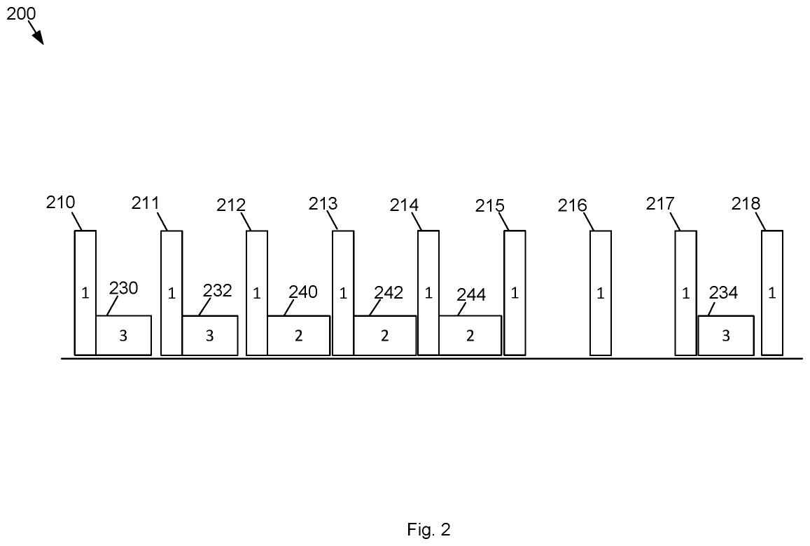

FIG. 2 illustrates distribution of traffic 200 for stations coupled to Extender 2.

In FIG. 2, transmissions from STA #1 210-218 are spaced out relatively evenly across the time interval. Traffic from STA #2 240-244 and STA #3 230-234 mixed in across the timeline. Referring both to FIG. 1 and FIG. 2, all the traffic 210-218, 230-234, 240-244 gets compressed into a single queue from Extender 2 130 to Extender 1 120 so the explicit schedule that STA #1 132 has developed with Extender 2 130 is lost. And similarly, if STA #5 122, for example, behaves the same way as STA #1 132 at Extender 1 130, that traffic would all collapse into traffic of a single queue at Extender 1 120, and again the traffic of STA #5 122 and the traffic of STA #1 132 would lose the schedule developed with Extender 1 120. As the traffic goes across the backhaul 160 to Broadband Gateway 110, the fidelity that initially existed when traffic was being transmitted by the different stations is lost. This schedule is important for low latency because if this relationship/schedule is lost, data ends up being clumped together at the Broadband Gateway 110. The Broadband Gateway 110 may decide that that traffic is no longer low latency because the data is too clumped. Thus, the Broadband Gateway 110 will reject this as low latency and just provide normal processing. Thus, the goal is to try to align the OFDMA schedule that STA #1 132 and Extender 2 130 have, the schedule that STA #5 122 and Extender 1 120 have, and the schedule that STA #7 112 and the Broadband Gateway 110 have so that backhaul links 150, 160 are properly managed with an appropriate schedule as far those different devices are concerned.

In FIG. 1, Extender 2 130 observes the repetitive schedule 170 that STA #1 132 requests grants to transmit data by Extender 2 130. Extender 1 120 then retrieves that observed OFDMA repetitive schedule 171 from Extender 2. Extender 1 120 also observes OFDMA repetitive schedule 172 by STA #5 122 and STA #6. Extender 1 120 may also obtain OFDMA repetitive schedule from Extender 3 140 based on requests for grants to transmit data for STA #4 142.

Broadband Gateway 110 obtains observed OFDMA repetitive schedule 172 of Extender 1 120 (E1, 5) and the retrieved OFDMA repetitive schedule 171 (E2, 1) that Extender 1 120 obtained from Extender 2 130. Broadband Gateway 110 may also be coupled to STA #7 112 and obtain observed schedule 174 (GW, 7) of STA #7 112. Broadband Gateway 110 then determines a derived OFDMA repetitive schedule 175 for itself (GW 7), Extender 1 120 (E1, 5), and Extender 2 130 (E2, 1). Broadband Gateway 110 can supply derived OFDMA repetitive schedule 175 for itself (GW 7) to its own local interface for use with STA #7 112. Broadband Gateway 110 provides on its backhaul interface Derived OFDMA repetitive schedule 176 (E1, 5; E2, 1) to Extender 1 120. Extender 1 120 uses Derived OFDMA repetitive schedule 176 (E1, 5) with STA #5 122. Based on receipt of Derived OFDMA repetitive schedule 176 (E1, 5; E2, 1), Extender 1 120 forwards Derived OFDMA repetitive schedule 177 (E2, 1) to Extender 2 130.

Thus, Broadband Gateway 110 is able to realize the Derived OFDMA repetitive schedules 175, 176, 177 for each of the primary low latency devices, i.e., STA #1 132, STA #5 122, and STA #7 112, and be able to propagate the respective Derived OFDMA repetitive schedules 176, 177 back down to the different extenders, i.e., Extender 1 120, Extender 2 130, to make sure each of those extenders then can properly deliver on the respective Derived OFDMA repetitive schedules 176, 177 as required. To avoid conflicts, the Derived OFDMA repetitive schedules 175 176, 177 (GW, 7; E1, 5; E2, 1) may be offset so that the stations are not trying to transmit at the exact same time.

While this process here has been described for upstream data transfers, the same process may be applied in reverse for downstream data transfer. In this scenario, Broadband Gateway 110, when it receives traffic on the downstream direction, would also realize there's a repetitive pattern (which is not show in FIG. 1). Broadband Gateway 110 would identify the repetitive pattern and then make sure that each of the backhaul links 160, 150, 180, respectively, to Extender 1 120, Extender 2 130, and Extender 3 140, are properly primed to deliver that traffic on that repetitive schedule.

Thus, a more controlled latency scheme is provided for devices that have repetitive schedules. Such information may be provided using a Type-Length Value (TLV) as described in the he Wi-Fi Alliance Easy Mesh specification. The Type-Length Value (TLV) as described in the Wi-Fi Alliance Easy Mesh specification has been defined to call out anticipated channel usage. This allows each of Extender 1 120, Extender 2 130, and Extender 3 140 to report information about repetitive schedules that they have observed from connected stations. This information is reported back to a central controller, such as may be provided by Broadband Gateway 110. However, while The TLV may be used to communicate anticipated channel usage, currently there is no mechanism specified to provide the ability to modify the behavior of the backhaul link support and derive repetitive OFDMA schedules that can be installed in each of the network controllers to improve overall network behavior, and to improve low latency and performance of the mesh network. The process described above provides the ability to modify the behavior of the backhaul link support and derive OFDMA repetitive schedules that can be installed in each of the network controllers.

Instead of having the Broadband Gateway 110 obtain the OFDMA repetitive schedules 171, 172, each network device, such as Extender 1 120, Extender 2 130, and Extender 3 140, could determine the Derived OFDMA repetitive schedules 176, 177 for itself or a neighboring node. For example, Extender 1 could determine the Derived OFDMA repetitive schedules 176, 177, use Derived OFDMA repetitive schedule E1, 5 for use with STA #5 122, and forward Derived OFDMA repetitive schedule E2, 1 to Extender 2 130 for use with STA #1. Further, Extender 1 120 and Extender 2 130 may determine Derived OFDMA repetitive schedules for their own stations, such that Extender 2 120 determines Derived OFDMA repetitive schedule E1, 5 for use with STA #5 122 and Extender 2 130 determines Derived OFDMA repetitive schedule E2, 1 for use with STA #1 132.

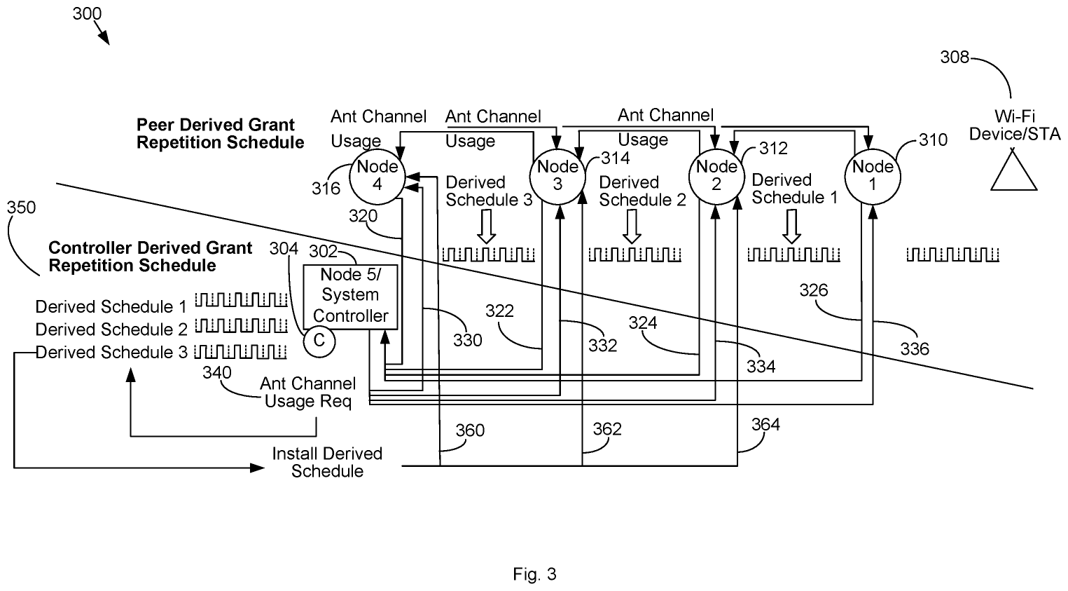

FIG. 3 shows a system 300 that uses a System Controller for performing schedule derivation.

In FIG. 3, a System Controller (Node 5) 302 is coupled to each of the other nodes in the network, e.g., Node 1 310, Node 2 312, Node 3 314, Node 4 316, which may be Extenders, Access Points, or other types of network devices. A greater number or a few number of nodes may be provided in the network and coupled to the System Controller 302. Each of Node 1 310, Node 2 312, Node 3 314, and Node 4 316 may be coupled to a Wi-Fi Device/Station (STA) 308. Each of Node 1 310, Node 2 312, Node 3 314, and Node 4 316 may provide information about observed OFDMA repetitive schedules 320-326 to the System Controller 302. Alternatively, System Controller 302 may determine OFDMA repetitive schedules for each of Node 1 310, Node 2 312, Node 3 314, and Node 4 316 based on upstream traffic 320-326 received from each of Node 1 310, Node 2 312, Node 3 314, and Node 4 316. Transmission grants are provided by nodes 310-316.

System Controller 302 may forward downstream traffic 330-336 to Node 1 310, Node 2 312, Node 3 314, and Node 4 316. System Controller 302 may also be coupled to a STA 304, as represented by device C in FIG. 3. As one example, anticipated usage requirements 340 from Node 2 312, Node 3 314, and Node 4 316 may be used to determine Derived OFDMA repetitive schedules 350. Derived OFDMA repetitive schedules 350 are then provided 360, 362, 364 by System Controller 302 , respectively, to Node 2 312, Node 3 314, and Node 4 316. One or more of Derived OFDMA repetitive schedules 360, 362, 364 may be based on bandwidth demand, such as needed by a voice call. To avoid conflicts, the Derived OFDMA repetitive schedules 360, 362, 364 may be offset so that Node 2 312, Node 3 314, and Node 4 316 are not trying to transmit at the exact same time.

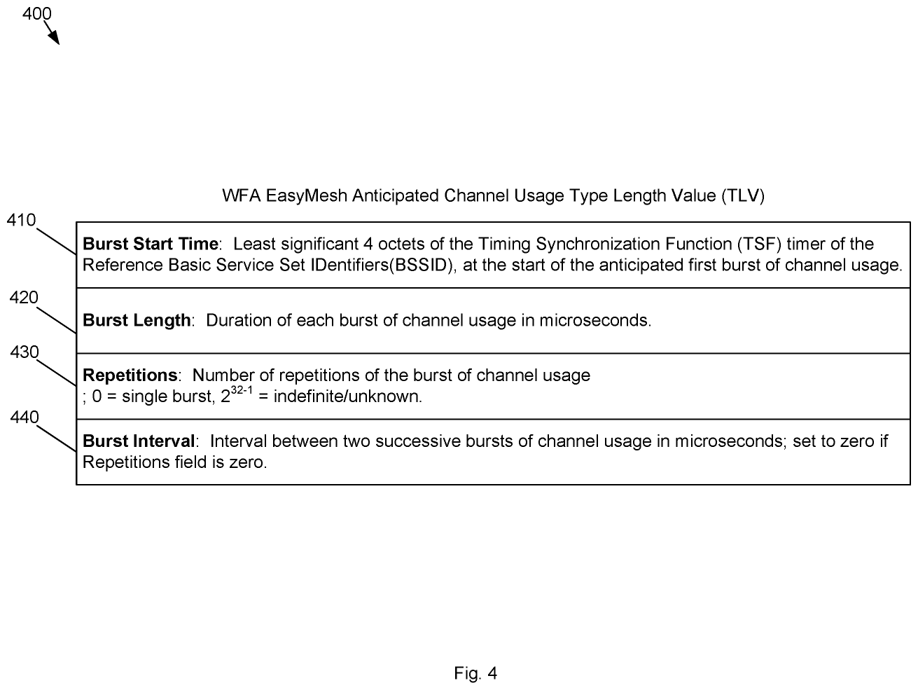

FIG. 4 shows Type-Length Values (TLVs) for anticipated channel usage 400.

In FIG. 4, a Burst Start Time TLV 410 uses the least significant 4 octets of the Timing Synchronization Function (TSF) timer of the Reference Basic Service Set Identifiers (BSSID) to identify the start of the anticipated first burst of channel usage. The Burst Length TLV 420 identifies the duration of each burst of channel usage in microseconds. The Repetitions TLV 430 identifies the number of repetitions of the burst of channel usage, wherein 0=single burst, and 232−1=indefinite/unknown. The Burst Interval TLV 440 identifies the interval between two successive bursts of channel usage in microseconds. The value is set to zero if Repetitions field is zero.

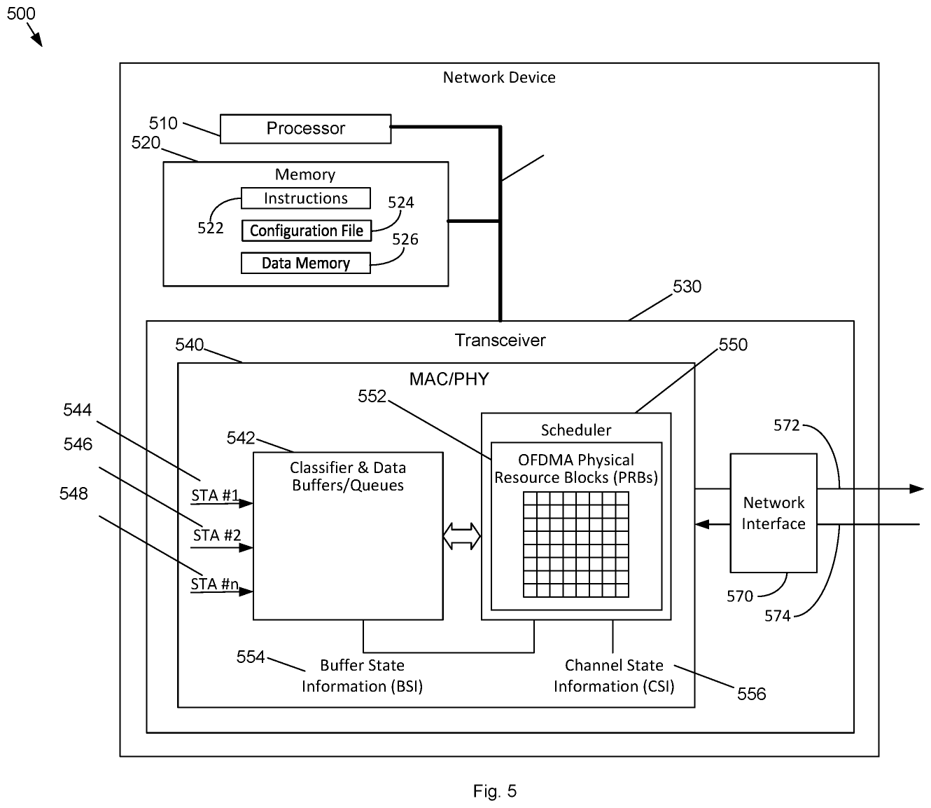

FIG. 5 shows a network device 500 for aligning multiple Orthogonal Frequency-Division Multiple Access (OFDMA) scheduler grants to minimize end-to-end latency in mesh networks.

In FIG. 5, the network device 500 includes a processor 510 and memory 520. Memory 520 may include instructions 522 for implementing the functions to align OFDMA scheduler grants to minimize end-to-end latency in mesh networks. Processor 510 executes the instructions 522 to align OFDMA scheduler grants to minimize end-to-end latency in mesh networks. A configuration file 524 may be used to configure the network device 500. Data Memory 526 may store data for use in deriving OFDMA repetitive schedules. For example, network nodes may provide observed OFDMA repetitive schedules to network device 500 and store the observed OFDMA repetitive schedules. Processor 510 processes the observed OFDMA repetitive schedules to determine derived OFDMA repetitive schedules.

Network device 500 further includes a transceiver 530 for processing data received at network interface 570 via input 572 and data for transmission via network interface 570 using output 574. Transceiver 530 includes a Media Access Control (MAC)/Physical (PHY) interface 540. MAC/PHY interface 540 includes a classifier and data buffer/queues 542 for handling data of stations, e.g., STA #1 544, STA #2 546, STA #n 548. A scheduler 550 is coupled to the classifier and data buffer/queues 542. Traffic is queued into separate per flow queues by classifier and data buffer/queues 542, and the traffic is scheduled using designated flows, such as best effort, low latency, etc. The scheduler 550 may use OFDMA to improve wireless network performance by establishing independently modulating subcarriers within frequencies. This approach allows simultaneous transmissions to and from multiple clients. In OFDMA, the radio resources are 2D regions over time (an integer number of OFDM symbols) and frequency (a number of contiguous or non-contiguous subcarriers). OFDMA employs multiple closely spaced subcarriers that are divided into groups of subcarriers where each group is called a resource block. The grouping of subcarriers into groups of resource blocks is referred to as sub-channelization. The subcarriers that form a resource block do not need to be physically adjacent. Buffer State Information (BSI) 554 is provided to make transmission decisions. BSI allows for optimize transmission by excluding relays with full buffers from receiving and relays with empty buffers from transmitting. The Scheduler 550 uses Channel State Information (CSI) 556 to increase capacity, and decrease the total transmission power.

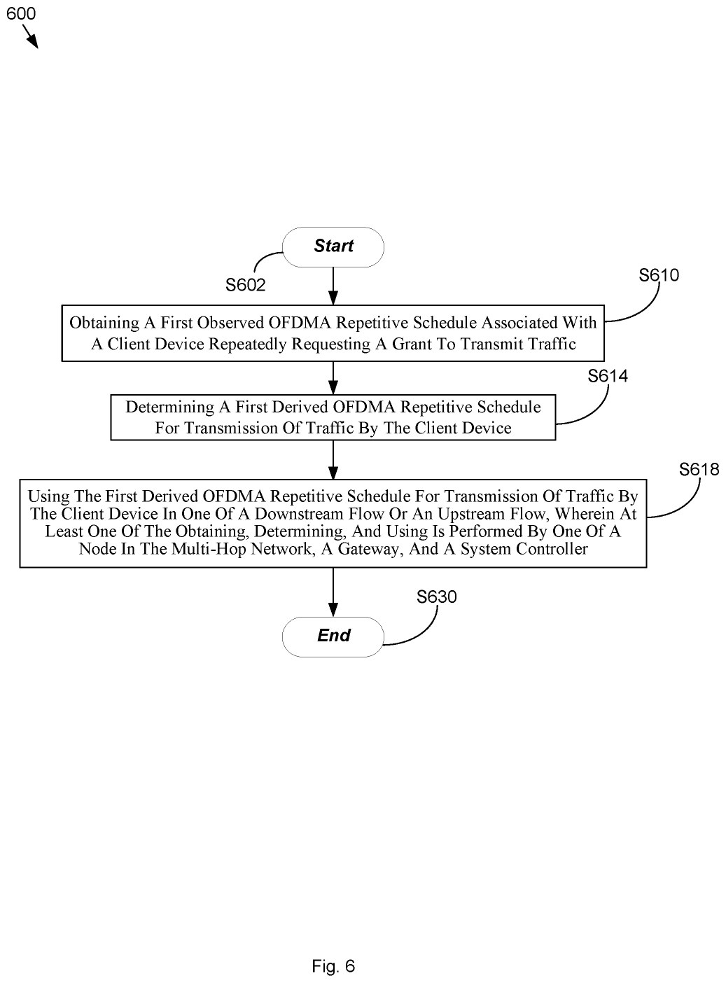

FIG. 6 is a flow chart of a method 600 for aligning multiple Orthogonal Frequency-Division Multiple Access (OFDMA) scheduler grants to minimize end-to-end latency in mesh networks.

In FIG. 6, method 600 starts (S602), and a first Observed OFDMA Repetitive Schedule associated with a client device repeatedly requesting a grant to transmit traffic is obtained (S610). Referring to FIG. 1, Extender 2 130 observes the repetitive schedule 170 that STA #1 132 has, and Extender 1 120 can then retrieve that repetitive schedule 170 from Extender 2, but Extender 1 can also observe other schedules 172 that it sees, such as from STA #5 122. Similarly the Broadband Gateway 110 can retrieve those two schedules 173, e.g., the schedule for Extender 1 120 and STA #5 122, and the schedule for Extender 2 130 and STA #1 132, and combine it with an observed schedule 174 of STA #7 112 that is connected to the Broadband Gateway 110. Referring to FIG. 3, Each of Node 1 310, Node 2 312, Node 3 314, and Node 4 316 may provide information about observed OFDMA repetitive schedules 320-326 to the System Controller 302. Alternatively, System Controller 302 may determine OFDMA repetitive schedules for each of Node 1 310, Node 2 312, Node 3 314, and Node 4 316 based on upstream traffic 320-326 received from each of Node 1 310, Node 2 312, Node 3 314, and Node 4 316.

A first Derived OFDMA Repetitive Schedule for transmission of traffic by the client device is determined (S620). Referring to FIG. 1, the Broadband Gateway 110 can then determine a derived OFDMA repetitive schedule 175 that the Broadband Gateway 110 can supply to its own local interface and its own backhaul interface, as well as providing Derived OFDMA repetitive schedule 176 to Extender 1 120 and then Derived OFDMA repetitive schedule 177 to Extender 2 130. Referring to FIG. 3, anticipated usage requirements 340 from Node 2 312, Node 3 314, and Node 4 316 may be used to determine Derived OFDMA repetitive schedules 350.

The first Derived OFDMA Repetitive Schedule is used for transmission of traffic by the client device in one of a downstream flow or an upstream flow, wherein at least one of the obtaining, determining, and using is performed by one of a node in the multi-hop network, a gateway, and a system controller (S630). Referring to FIG. 1, the Broadband Gateway propagates the respective Derived OFDMA repetitive schedules 176, 177 back down to the different extenders, i.e., Extender 1 120, Extender 2 130, to make sure each of those extenders then can properly deliver on the respective Derived OFDMA repetitive schedules 176, 177 as required. Referring to FIG. 3, Derived OFDMA repetitive schedules 350 are then provided 360, 362, 364 by System Controller 302 , respectively, to Node 2 312, Node 3 314, and Node 4 316. One or more of Derived OFDMA repetitive schedules 360, 362, 364 may be based on bandwidth demand, such as needed by a voice call. To avoid conflicts, the Derived OFDMA repetitive schedules 360, 362, 364 may be offset so that Node 2 312, Node 3 314, and Node 4 316 are not trying to transmit at the exact same time.

The method then ends (S630).

Accordingly, a network device may be used to align Orthogonal Frequency-Division Multiple Access (OFDMA) schedules across nodes in a multi-hop network. The network device may include a processor that is configured to obtain a first observed OFDMA repetitive schedule associated with a client device repeatedly requesting a grant to transmit traffic and determine a derived OFDMA repetitive schedule for transmission of traffic by the client device. The derived OFDMA repetitive schedule may be used for transmission of traffic by the client device in one of a downstream flow or an upstream flow. The network device may be coupled directly to a client device or to another network node in the mesh network, or may be a broadband gateway that determines a derived OFDMA repetitive schedule for itself and/or other network nodes in the network. The network device may also be a system controller that is coupled to each node in the network and determines the derived OFDMA repetitive schedule for each node in the network.

The subject matter of the present disclosure may be provided as a computer program product including one or more non-transitory computer-readable storage media having stored thereon instructions (in compressed or uncompressed form) that may be used to program a computer (or other electronic device) to perform processes or methods described herein. The computer-readable storage media may include one or more of an electronic storage medium, a magnetic storage medium, an optical storage medium, a quantum storage medium, or the like. For example, the computer-readable storage media may include, but are not limited to, hard drives, floppy diskettes, optical disks, read-only memories (ROMs), random access memories (RAMs), erasable programmable ROMs (EPROMs), electrically erasable programmable ROMs (EEPROMs), flash memory, magnetic or optical cards, solid-state memory devices, or other types of physical media suitable for storing electronic instructions.

Further, the subject matter of the present disclosure may also be provided as a computer program product including a transitory machine-readable signal (in compressed or uncompressed form). Examples of machine-readable signals, whether modulated using a carrier or unmodulated, include, but are not limited to, signals that a computer system or machine hosting or running a computer program may be configured to access, including signals transferred by one or more networks. For example, a transitory machine-readable signal may comprise transmission of software by the Internet.

Separate instances of these programs can be executed on or distributed across any number of separate computer systems. Thus, although certain steps have been described as being performed by certain devices, software programs, processes, or entities, this need not be the case. A variety of alternative implementations will be understood by those having ordinary skill in the art.

Additionally, those having ordinary skill in the art readily recognize that the techniques described above can be utilized in a variety of devices, environments, and situations. Although the subject matter has been described in language specific to structural features or methodological acts, it is to be understood that the subject matter defined in the appended claims is not necessarily limited to the specific features or acts described. Rather, the specific features and acts are disclosed as exemplary forms of implementing the claims.

What is claimed is:

1. A network device for aligning Orthogonal Frequency-Division Multiple Access (OFDMA) schedules across nodes in a multi-hop network, comprising:
a memory storing computer-readable instructions; and
a processor configured to execute the computer-readable instructions to:
obtain a first observed OFDMA repetitive schedule associated with a client device repeatedly requesting a grant to transmit traffic; and
determine a first derived OFDMA repetitive schedule for transmission of traffic by the client device.

2. The network of claim 1, wherein processor uses the first derived OFDMA repetitive schedule for transmission of traffic by the client device in one of a downstream flow or an upstream flow.

3. The network of claim 1, wherein the processor provides a gateway for controlling access to a second network by the nodes in the multi-hop network.

4. The network of claim 3, wherein the processor communicates directly with a first node in the multi-hop network, the first node being coupled to the client device, wherein the processor obtains the first observed OFDMA repetitive schedule associated with the client device directly from the first node, and wherein the processor sends the first derived OFDMA repetitive schedule directly to the first node.

5. The network of claim 3, wherein the processor communicates with an intermediary node positioned between the network device and a subsequent node in the multi-hop network, the client device being coupled to the subsequent node, and wherein the processor obtains the first observed OFDMA repetitive schedule associated with the client device relayed by the intermediary node from the subsequent node and sends the first derived OFDMA repetitive schedule to the intermediary node for relaying to the subsequent node to use transmission of traffic by the client device.

6. The network of claim 1, wherein the processor provides a system controller, wherein the system controller communicates with each node in the multi-hop network.

7. The network of claim 6, wherein the system controller is coupled to each of N nodes in the multi-hop network, the system controller is configured to:
obtain N observed OFDMA repetitive schedules, each of the N observed OFDMA repetitive schedules associated with a respective one of the N nodes in the multi-hop network;
determine N derived OFDMA repetitive schedules based on the N observed OFDMA repetitive schedules, each of the N derived OFDMA repetitive schedules associated with the respective one of the N nodes in the multi-hop network; and
provide the N derived OFDMA repetitive schedules to the respective one of the N nodes in the multi-hop network for transmitting traffic.

8. A method for aligning Orthogonal Frequency-Division Multiple Access (OFDMA) schedules across nodes in a multi-hop network, comprising:
obtaining a first observed OFDMA repetitive schedule associated with a client device repeatedly requesting a grant to transmit traffic; and
determining a first derived OFDMA repetitive schedule for transmission of traffic by the client device.

9. The method of claim 8, wherein the determining the first derived OFDMA repetitive schedule further comprises calculating the first derived OFDMA repetitive schedule for the client device, the first derived OFDMA repetitive schedule being used for transmission of traffic by the client device in one of a downstream flow or an upstream flow.

10. The method of claim 8 further comprising providing a gateway for controlling access to a second network by the nodes in the multi-hop network, the gateway obtaining the first observed OFDMA repetitive schedule and determining the first derived OFDMA repetitive schedule.

11. The method of claim 10, wherein the obtaining the first observed OFDMA repetitive schedule associated with the client device further comprises communicating, by the gateway, directly with a first node in the multi-hop network that is coupled to the client device to obtain the first observed OFDMA repetitive schedule, and wherein the first derived OFDMA repetitive schedule is sent, by the gateway, directly to the first node.

12. The method of claim 10, wherein the obtaining the first observed OFDMA repetitive schedule associated with the client device further comprises obtaining, by the gateway, the first observed OFDMA repetitive schedule from an intermediary node positioned before a subsequent node in the multi-hop network, the first observed OFDMA repetitive schedule associated with the client device being relayed by the intermediary node from the subsequent node.

13. The method of claim 8 further comprising providing a system controller, wherein the system controller communicates with each node in the multi-hop network.

14. The method of claim 13 further comprising
obtaining, by the system controller, N observed OFDMA repetitive schedules, one of the N observed OFDMA repetitive schedules obtained by the system controller from each of N nodes in the multi-hop network;
determining, by the system controller, N derived OFDMA repetitive schedules based on the N observed OFDMA repetitive schedules, each of the N derived OFDMA repetitive schedules associated with the respective one of the N nodes in the multi-hop network; and
providing, by the system controller, the N derived OFDMA repetitive schedules to the respective one of the N nodes in the multi-hop network for transmitting traffic.

15. A non-transitory computer-readable media having computer-readable instructions stored thereon, which when executed by a processor causes the processor to perform operations comprising:
obtaining a first observed OFDMA repetitive schedule associated with a client device repeatedly requesting a grant to transmit traffic; and
determining a first derived OFDMA repetitive schedule for transmission of traffic by the client device.

16. The non-transitory computer-readable media of claim 15, wherein the determining the first derived OFDMA repetitive schedule further comprises calculating the first derived OFDMA repetitive schedule for the client device, the first derived OFDMA repetitive schedule being used for transmission of traffic by the client device in one of a downstream flow or an upstream flow.

17. The non-transitory computer-readable media of claim 15 further comprising providing a gateway for controlling access to a second network by the nodes in the multi-hop network, the gateway obtaining the first observed OFDMA repetitive schedule and determining the first derived OFDMA repetitive schedule.

18. The non-transitory computer-readable media of claim 17, wherein the obtaining the first observed OFDMA repetitive schedule associated with the client device further comprises communicating, by the gateway, directly with a first node in the multi-hop network that is coupled to the client device to obtain the first observed OFDMA repetitive schedule, and wherein the first derived OFDMA repetitive schedule is sent, by the gateway, directly to the first node.

19. The non-transitory computer-readable media of claim 17, wherein the obtaining the first observed OFDMA repetitive schedule associated with the client device further comprises obtaining, by the gateway, the first observed OFDMA repetitive schedule from an intermediary node positioned before a subsequent node in the multi-hop network, the first observed OFDMA repetitive schedule associated with the client device being relayed by the intermediary node from the subsequent node.

20. The non-transitory computer-readable media of claim 15 further comprising:
providing a system controller, wherein the system controller communicates with each node in the multi-hop network;
obtaining, by the system controller, N observed OFDMA repetitive schedules, one of the N observed OFDMA repetitive schedules obtained by the system controller from each of N nodes in the multi-hop network;
determining, by the system controller, N derived OFDMA repetitive schedules based on the N observed OFDMA repetitive schedules, each of the N derived OFDMA repetitive schedules associated with the respective one of the N nodes in the multi-hop network; and
providing, by the system controller, the N derived OFDMA repetitive schedules to the respective one of the N nodes in the multi-hop network for transmitting traffic.
